(19) United States
(12) Patent Application Publication
(10) Pub. No.: US 2023/0120680 A1
(43) Pub. Date: Apr. 20, 2023

(54) METHOD AND DEVICE FOR MARKING DIRTY BITS IN L2P TABLE BASED ON SOLID STATE DRIVE

(71) Applicant: SHENZHEN UNIONMEMORY INFORMATION SYSTEM LIMITED, Shenzhen, Guangdong (CN)

(72) Inventors: An YU, Shenzhen (CN); Haidong ZHENG, Shenzhen (CN); Haibin WANG, Shenzhen (CN); Jintao GAN, Shenzhen (CN); Weiliang WANG, Shenzhen (CN); Zongming JIA, Shenzhen (CN)

(21) Appl. No.: 17/043,536

(22) PCT Filed: Feb. 26, 2020
(86) PCT No.: PCT/CN2020/076772

§ 371 Date: Sep. 29, 2020

(30) Foreign Application Priority Data
Sep. 17, 2019 (CN) 201910876237.9

(51) Int. Cl. G06F 12/1009

(52) U.S. Cl. CPC G06F 12/1009; G06F 2212/1024

(57) ABSTRACT

The present application discloses a method and a device for marking dirty bits of an L2P table based on a SSD, the method includes: obtaining a marking request of dirty bits in the L2P table based on the solid state drive; and broadening a corresponding dirty bit in the L2P table to 2 bits according to the request; and setting the dirty bit from a binary number 00 to a binary number 01 through a state machine when a first write command request is obtained; setting the dirty bit from the binary number 01 to a binary number 10 through the state machine when flush operation starts; and setting the dirty bit from the binary number 10 to a binary number 11 through the state machine when a second write command request is obtained during the flush operation.

### CROSS REFERENCE TO RELATED APPLICATIONS

The present application is a National Stage Application filed under USC 371 of International Patent Application No. PCT/CN2020/076772 with an international filing date of Feb. 26, 2020, designating the United States, now pending, and further claims the priority of CN patent application submitted at the Chinese Patent Office on Sep. 17, 2019, with application No. 201910876237.9, titled “method and device for marking dirty bits in L2P table based on solid state drive”, the whole contents each of which are incorporated herein by reference thereto.

### TECHNICAL FIELD

The present application relates to the technical field of solid state drive (SSD), and more particularly to a method and a device for marking dirty bits in an L2P table based on SSD.

### BACKGROUND

At present, SSDs have been widely used in various occasions. Due to their excellent indicators in performance, power consumption, and environmental adaptability, they are gradually replacing traditional hard drives.

In the traditional L2P table management technology based on SSD, the dirty bit is 1 bit. When the 1-bit dirty bit is used, after the L2P table flush starts and before the flush completes the dirty clearing, if the dirty bit is 1, the 1 state will be cleared by the following dirty clearing, so the dirty state will be lost. The traditional solution is to avoid the dirty bit being 1 after the start of the L2P table flush and before the flush completes the dirty clearing. In order to do this, it is necessary to prohibit processing write commands within the range of this L2P table for a while, so that the write commands are blocked, which affects write performance.

### SUMMARY

One of the objects of embodiments of the present application is to provide a method and a device for marking dirty bits in an L2P table based on SSD, in order to solve the problem of prohibiting processing write commands within the range of this L2P table, such that the write commands are blocked, and write performance is affected.

In order to solve above technical problem, the present application adopts the technical scheme as following:

In a first aspect, a method for marking dirty bits in an L2P table based on a solid state drive is provided, which including:

obtaining a marking request of dirty bits in the L2P table based on the solid state drive;

broadening a corresponding dirty bit in the L2P table to 2 bits according to the request;

setting the dirty bit from a binary number 00 to a binary number 01 through a state machine when a first write command request is obtained;

setting the dirty bit from the binary number 01 to a binary number 10 through the state machine when flush operation starts; and

setting the dirty bit from the binary number 10 to a binary number 11 through the state machine when a second write command request is obtained during the flush operation.

In a second aspect, a device of marking dirty bits in an L2P table based on a solid state drive is provided, which including;

an obtaining module, configured for obtaining a marking request of dirty bits in the L2P table based on the solid state drive;

a broadening module, configured for broadening a corresponding dirty bit in the L2P table to 2 bits according to the request;

a first skipping module, configured for setting the dirty bit from a binary number 00 to a binary number 01 through a state machine when a first write command request is obtained, and setting the dirty bit from the binary number 01 to a binary number 10 through the state machine when flush operation starts; and

a second skipping module, configured for setting the dirty bit from the binary number 10 to a binary number 11 through the state machine when a second write command request is obtained during the flush operation.

In a third aspect, a computer device is provided, which including: a processor, and a computer program stored on the memory and operating on the processor, and the processor implements the steps of the method for marking dirty bits in an L2P table based on a solid state drive of the first aspect when the processor executes the computer program

In a fourth aspect, a computer readable storage medium is provided, the computer readable storage medium is stored thereon with a computer program, and the steps of the method for marking dirty bits in an L2P table based on a solid state drive of the first aspect are implemented when the computer program is executed by a processor.

The beneficial effects of the method and device for marking the dirty bits of the L2P table based on the SSD provided in the embodiments of the present application are: the present application by obtaining a marking request of dirty bits in the L2P table based on the solid state drive; and broadening a corresponding dirty bit in the L2P table to 2 bits according to the request; and setting the dirty bit from a binary number 00 to a binary number 01 through a state machine when a first write command request is obtained; setting the dirty bit from the binary number 01 to a binary number 10 through the state machine when flush operation starts; and setting the dirty bit from the binary number 10 to a binary number 11 through the state machine when a second write command request is obtained during the flush operation. The present application adopts a 2-bit dirty bit to represent 4 different states through the 2-bit dirty bit, and the skipping mechanism of the state machine is adopted to realize that there is no need to block write commands during flash programming, which is beneficial to improve write performance and reduce write latency.

### BRIEF DESCRIPTION OF THE DRAWINGS

FIG. 1 is a schematic diagram of marking state of dirty bits in an L2P table in SSD of traditional technology;

FIG. 2 is a schematic flowchart of a method for marking dirty bits in an L2P table based on a solid state drive in an embodiment;

FIG. 3 is a schematic flowchart of a method for marking dirty bits in an L2P table based on a solid state drive in another embodiment;

FIG. 4 is a schematic flowchart of a method for marking dirty bits in an L2P table based on a solid state drive in a further embodiment;

FIG. 5 is a schematic flowchart of a method for marking dirty bits in an L2P table based on a solid state drive in a yet embodiment;

FIG. 6 is a schematic diagram of a state of a dirty bit in a scenario where a write command occurs between t1 and t3 in an embodiment;

FIG. 7 is a schematic diagram of a state of a dirty bit in a scenario where no write command occurs between t1 and t3 in an embodiment;

FIG. 8 is a schematic diagram of state slipping of a state machine in an embodiment;

FIG. 9 is a structural block diagram of a device of marking dirty bits in an L2P table based on a solid state drive in an embodiment;

FIG. 10 is a structural block diagram of a device of marking dirty bits in an L2P table based on a solid state drive in another embodiment; and

FIG. 11 is an internal structure diagram of a computer device in an embodiment.

### DETAILED DESCRIPTION

In order to make the purpose, technical solutions, and advantages of the present application clearer, the following further describes the present application in detail with reference to the accompanying drawings and embodiments. It should be understood that the specific embodiments described herein are only used to explain the application, and not used to limit the application.

In traditional technology, the dirty bit is 1 bit, and the L2P table in the cache is a copy of the L2P table in the flash. When the write command is executed, the system will update the L2P table in the cache, so that when the L2P table in the cache is inconsistent with the L2P table in the flash, in order to record the inconsistent information, setting the dirty bit. Later, when appropriate, the system flushes the L2P table in the cache to the flash. When the flush is completed, the L2P table in the cache and flash is consistent again, and the system clears the dirty bit to 0.

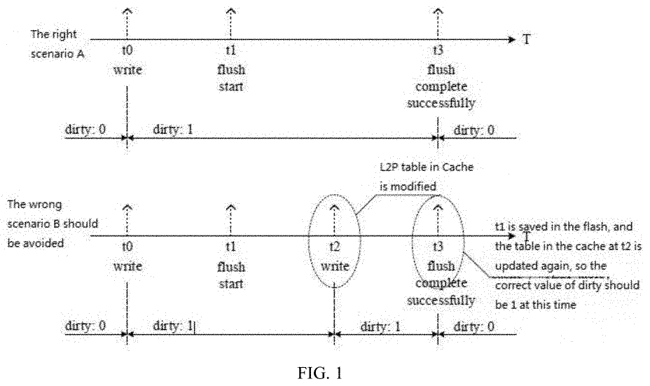

The whole process is shown in FIG. 1: At t0, a write command is executed, so the system modifies the L2P table in the cache, and the dirty bit is set to 1. At t1, the system initiates a flush operation and saves the L2P table at t1 to the flash, because it takes several hundred microseconds to program the flash, the flush is completed at t3. If the flash is successfully programmed at t3, it means that the L2P table in the flash is consistent with that in the cache, so the dirty bit is cleared. If the flash programming fails at t3, the dirty bit cannot be cleared and you need to choose an opportunity to initiate the flush again.

There is a loophole in this process: if at t2 between t1 and t3, a write command happens to modify the L2P table in the cache, the dirty bit will be 1, but if flush is successful at t3, the dirty bit will be cleared, at t3, it is actually succeeded in saving the L2P table in the cache at t1 to the flash, but at t2 the L2P table in the cache was changed again, so the L2P table in the cache and flash was inconsistent at t3, thereby, at t3, the dirty bit cannot be cleared. To solve this problem, the usual approach is to block the write command between t1 and t3, that is, not to execute the write command. This causes the write command that should be executed at t2 to be postponed to execute after t3, which affects performance and latency.

Based on above technical problem, the present application provides a method for marking dirty bits in an L2P table based on SSD, which realized that there is no need to block the write command during flash programming between t1 and t3, thereby write performance is improved, and latency is reduced.

In order to explain the content of the present application more clearly, the terms and abbreviations in this application are explained as follows:

SSD: Solid state drive;

flash: a non-volatile memory;

L2P table: Logic Page Address To Physical Page Address mapping table;

Dirty: characterizes whether the L2P table in the cache and flash is consistent, and if they are inconsistent, it is called dirty;

flush: In the present application, it specifically refers to programming the L2P table in the cache into the flash;

clear: In the present application, when the L2P table in the cache is successfully programmed into the flash, the dirty bit is marked as a non-dirty state.

bit: bit.

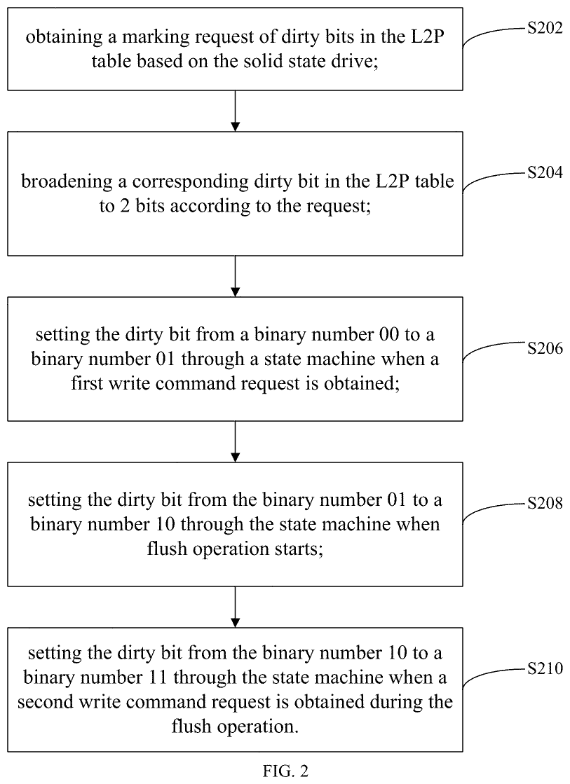

In an embodiment, as shown in FIG. 2, a method for marking dirty bits in an L2P table based on a SSD is provided, the method includes:

Step 202, obtaining a marking request of dirty bits in the L2P table based on the solid state drive;

Step 204, broadening a corresponding dirty bit in the L2P table to 2 bits according to the request;

Step 206, setting the dirty bit from a binary number 00 to a binary number 01 through a state machine when a first write command request is obtained;

Step 208, setting the dirty bit from the binary number 01 to a binary number 10 through the state machine when flush operation starts; and

Step 210, setting the dirty bit from the binary number 10 to a binary number 11 through the state machine when a second write command request is obtained during the flush operation.

Referring to the schematic diagram of the dirty bit state of the scenario where the write command occurs between t1 and t3 shown in FIG. 6. Specifically, firstly, obtaining a marking request of dirty bits in the L2P table based on the solid state drive, and broadening a corresponding dirty bit in the L2P table to 2 bits according to the request. Among them, the binary number 00 represents non-dirty, that is, the L2P table in the cache and flash is consistent; the binary number 01/10/11 both represent dirty, that is, the L2P table in the cache and flash is inconsistent. Specifically, a state machine can be introduced, and the 2-bit dirty bit is the state of the machine state. Before receiving the first write command request, the dirty bit is recorded as 00. After receiving the first write command request at time t0, the dirty bit is set from binary number 00 to binary number 01. Then, the flush operation starts at t1, and the dirty bit is set from the binary number 01 to the binary number 10 through the state machine. Since the entire flush operation takes a certain amount of time, if the second write command request is obtained during the flush operation, that is, at time t2 as shown in FIG. 6, the dirty bit is set from the binary number 10 to the binary number 11 through the state machine.

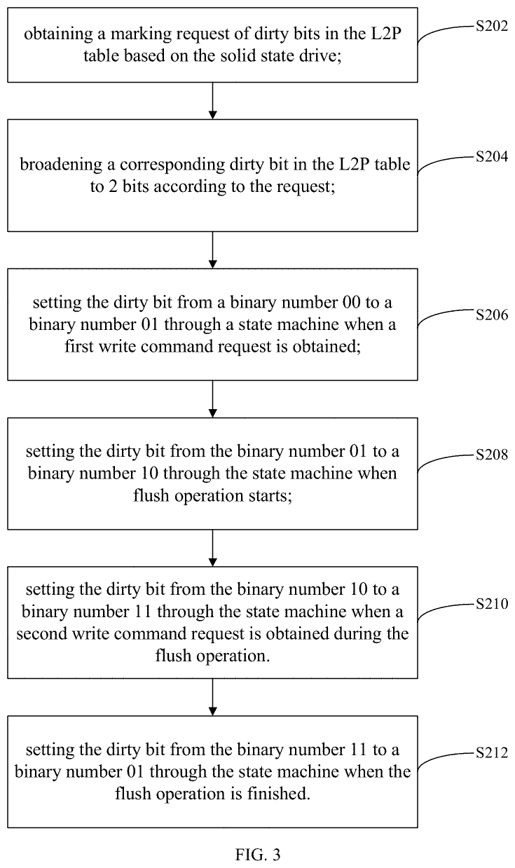

In an embodiment, as shown in FIG. 3, a method for marking dirty bits in an L2P table based on a SSD is provided, the method further includes the following step after the step 210:

Step 212, setting the dirty bit from the binary number 11 to a binary number 01 through the state machine when the flush operation is finished.

Similarly, referring to the schematic diagram of the dirty bit state of the scenario where the write command occurs between t1 and t3 shown in FIG. 6. At t3, setting the dirty bit from the binary number 11 to a binary number 01 through the state machine when the flush operation is finished.

When the 1-bit dirty bit was originally used, after the L2P table flush starts and before the flush completes the dirty clearing, if the dirty bit is 1, the 1 state will be cleared by the following dirty clearing, so the dirty state will be lost. The traditional solution is to avoid the dirty bit being 1 after the start of the L2P table flush and before the flush completes the dirty clearing. In order to do this, it is necessary to prohibit processing write commands within the range of this L2P table for a while, so that the write commands are blocked, which affects write performance. After adopting the method of the present application, after the start of L2P table flush and before the flush completes the dirty clearing, the write commands within the range of this L2P table can still be processed without blocking and the dirty marking will not be lost, which is beneficial to improve the write performance and shorten the write command response time.

In the above embodiment, the dirty bit is widened from the traditional 1-bit to 2-bit, and a state machine is introduced, and the 2-bit dirty bit is treated as the state bit of the state machine, which can solve the problem of dirty being set to 1 after the L2P table flush is started and before dirty is cleared, thereby achieving the purpose of improving write performance and reducing write latency.

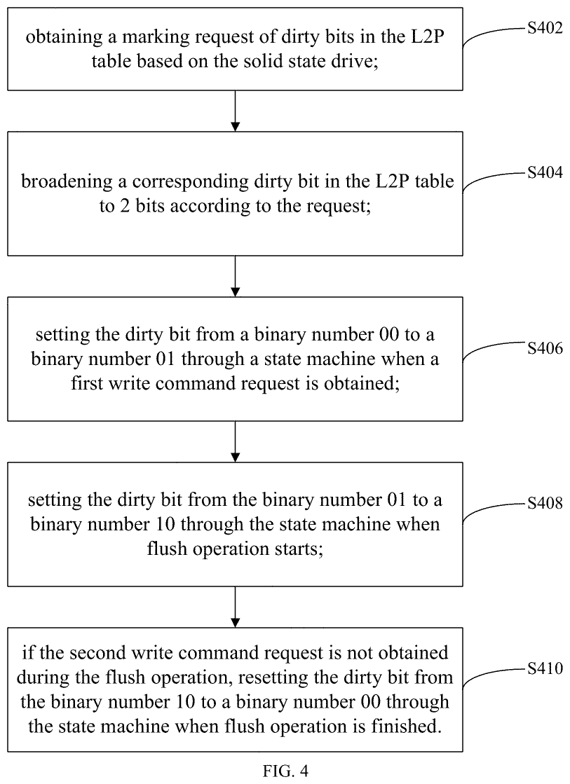

In an embodiment, as shown in FIG. 4, a method for marking dirty bits in an L2P table based on a SSD is provided, the method includes:

Step 402, obtaining a marking request of dirty bits in the L2P table based on the solid state drive;

Step 404, broadening a corresponding dirty bit in the L2P table to 2 bits according to the request;

Step 406, setting the dirty bit from a binary number 00 to a binary number 01 through a state machine when a first write command request is obtained;

Step 408, setting the dirty bit from the binary number 01 to a binary number 10 through the state machine when flush operation starts; and

Step 410, if the second write command request is not obtained during the flush operation, resetting the dirty bit from the binary number 10 to a binary number 00 through the state machine when flush operation is finished.

Referring to the schematic diagram of the dirty bit state of the scenario where no write command occurs between t1 and t3 shown in FIG. 7. Specifically, firstly, obtaining a marking request of dirty bits in the L2P table based on the solid state drive, and broadening a corresponding dirty bit in the L2P table to 2 bits according to the request. Among them, the binary number 00 represents non-dirty, that is, the L2P table in the cache and flash is consistent; the binary number 01/10/11 both represent dirty, that is, the L2P table in the cache and flash is inconsistent. Specifically, a state machine can be introduced, and the 2-bit dirty bit is the state of the machine state. Before receiving the first write command request, the dirty bit is recorded as 00. After receiving the first write command request at time t0, the dirty bit is set from binary number 00 to binary number 01. Then, the flush operation starts at t1, and the dirty bit is set from the binary number 01 to the binary number 10 through the state machine. Since the entire flush operation takes a certain amount of time, If there is no other write command request being obtained during the flush operation, the dirty bit is directly reset from the binary number 10 to the binary number 00 through the state machine when the flush operation is completed.

In the above-mentioned embodiment, it can be seen from these two typical scenarios that the consistency problem of the dirty bits between write, flush and clear is solved, and the write command does not need to be blocked in the time period of t1 and t3, thereby improving the write performance and reducing write latency.

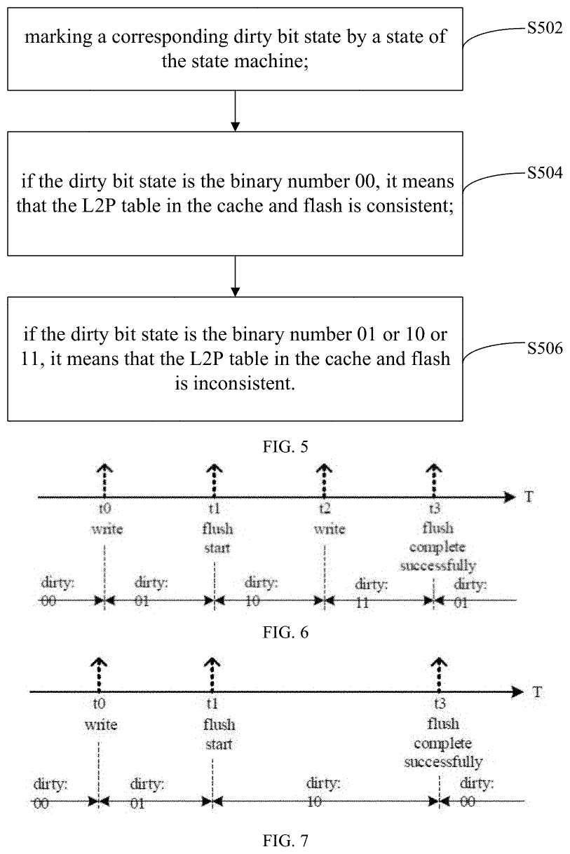

In an embodiment, as shown in FIG. 5, a method for marking dirty bits in an L2P table based on a SSD is provided, the method further includes:

Step 502, marking a corresponding dirty bit state by a state of the state machine;

Step 504, if the dirty bit state is the binary number 00, it means that the L2P table in the cache and flash is consistent; and

Step 506, if the dirty bit state is the binary number 01 or 10 or 11, it means that the L2P table in the cache and flash is inconsistent.

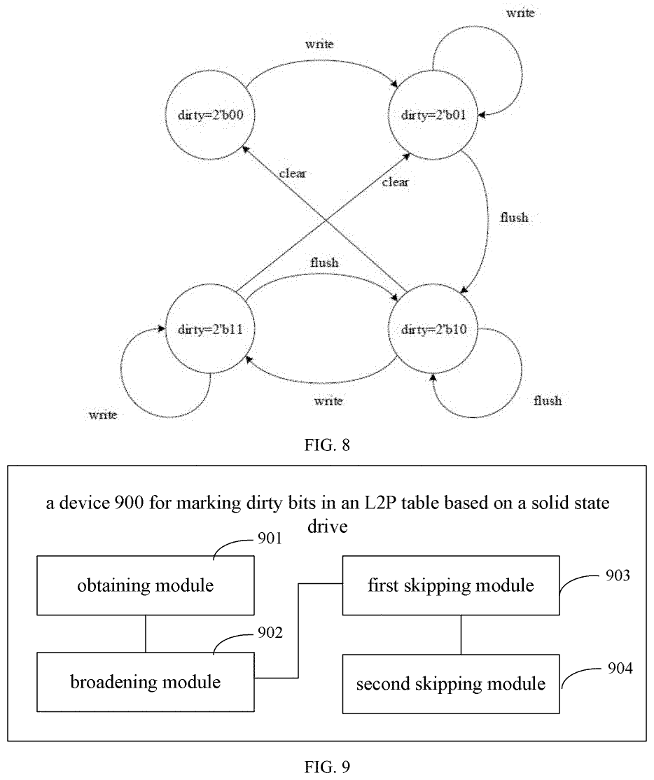

In the present embodiment, by introducing a state machine, the 2-bits dirty bit is the state of the machine state, as shown in FIG. 8 for details. The dirty bit uses 2-bits: the binary number 00 represents non-dirty, that is, the L2P table in the cache and flash is consistent; the binary number 01/10/11 both represent dirty, that is, the L2P table in the cache and flash is inconsistent.

There are four states of the state machine: binary numbers 00/01/10/11. It is understandable that the state machine can be realized not only by software, but also by hardware circuits, as long as it can realize a two-bit state skipping. Specifically, the state skipping mechanism of the state machine is shown in FIG. 8. When the first write command request is obtained, the state of the state machine skips from binary number 00 to binary number 01, and prepares to start the flush operation. At the beginning of the flush operation, the state of the state machine skips from the binary number 01 to the binary number 10. If the second write command request is obtained before the flush operation is completed, the state of the state machine skips from binary number 10 to binary number 11. After the flush operation is completed, the clear operation is performed, and the state of the state machine skips from binary number 11 to binary number 01. If the second write command request is not obtained before the flush operation is completed, the state of the state machine will skip directly from the binary number 10 to the binary number 00 after the flush operation is completed.

It should be understood that although the various steps in the flowcharts of FIGS. 2-5 are displayed in sequence as indicated by the arrows, these steps are not necessarily performed in sequence in the order indicated by the arrows. Unless specifically stated in the present application, the execution of these steps is not strictly limited in order, and these steps can be executed in other orders. Moreover, at least some of the steps in FIGS. 2-5 may include multiple sub-steps or multiple stages. These sub-steps or stages are not necessarily executed at the same time, but can be executed at different times. The order of execution of these sub-steps or stages is not necessarily executed in sequence, but can be executed alternately or alternately with other steps or at least part of the sub-steps or stages of other steps.

In an embodiment, as shown in FIG. 9, a device 900 for marking dirty bits in an L2P table based on a solid state drive, including:

an obtaining module 901, configured for obtaining a marking request of dirty bits in the L2P table based on the solid state drive;

a broadening module 902, configured for broadening a corresponding dirty bit in the L2P table to 2 bits according to the request;

a first skipping module 903, configured for setting the dirty bit from a binary number 00 to a binary number 01 through a state machine when a first write command request is obtained, and setting the dirty bit from the binary number 01 to a binary number 10 through the state machine when flush operation starts; and

a second skipping module 904, configured for setting the dirty bit from the binary number 10 to a binary number 11 through the state machine when a second write command request is obtained during the flush operation.

In an embodiment, the second skipping module 904 further configured for setting the dirty bit from the binary number 11 to a binary number 01 through the state machine when the flush operation is finished.

In an embodiment, the first skipping module 903 further configured for resetting the dirty bit from the binary number 10 to a binary number 00 through the state machine when flush operation is finished, if the second write command request is not obtained during the flush operation.

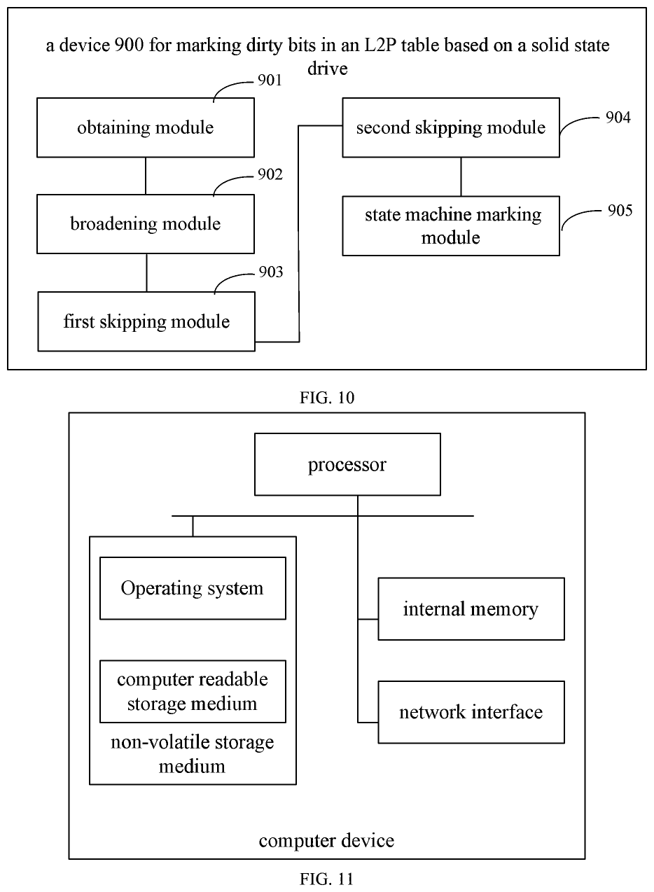

In an embodiment, as shown in FIG. 10, a device 900 for marking dirty bits in an L2P table based on a solid state drive, the device further includes a state machine marking module 905, and the state machine marking module 905 configured for:

marking a corresponding dirty bit state by a state of the state machine;

if the dirty bit state is the binary number 00, it means that the L2P table in the cache and flash is consistent; and

if the dirty bit state is the binary number 01 or 10 or 11, it means that the L2P table in the cache and flash is inconsistent.

Regarding the specific definition of the device for marking dirty bits in an L2P table based on a solid state drive please refer to the above limitation on the method or marking dirty bits in an L2P table based on a solid state drive, which will not be repeated here.

In an embodiment, a computer device is provided, and its internal structure diagram may be as shown in FIG. 11. The computer device includes a processor, a memory, and a network interface connected through a device bus. Among them, the processor of the computer device is used to provide calculation and control capabilities. The memory of the computer device includes a non-volatile storage medium and an internal memory. The non-volatile storage medium stores an operating device, a computer program, and a database. The internal memory provides an environment for the operation of the operating device and the computer program in the non-volatile storage medium. The network interface of the computer device is used to communicate with an external terminal through a network connection. When the computer program is executed by the processor, a method for marking dirty bits in an L2P table based on a solid-state drive is realized.

Those skilled in the art can understand that the structure shown in FIG. 11 is only a block diagram of part of the structure related to the solution of the present application, and does not constitute a limitation on the computer device to which the solution of the present application is applied. The specific computer device may include more or fewer parts than shown in the figure, or combining some parts, or having a different arrangement of parts.

In an embodiment, a computer device is provided, which includes a memory, a processor, and a computer program stored in the memory and capable of operating on the processor. The processor implements the steps in the above method embodiments when the computer program is executed.

In an embodiment, a computer readable storage medium is provided, on which a computer program is stored, and the computer program is executed by a processor to implement the steps in the above method embodiments.

A person of ordinary skill in the art can understand that all or part of the processes in the above-mentioned embodiment methods can be implemented by instructing relevant hardware through a computer program. The computer program can be stored in a non-volatile computer readable storage. In the medium, when the computer program is executed, it may include the procedures of the above-mentioned method embodiments. Among then, any reference to memory, storage, database, or other medium used in the embodiments provided in this application may include non-volatile and/or volatile memory. Non-volatile memory may include read-only memory (ROM), programmable ROM (PROM), electrically programmable ROM (EPROM), electrically erasable programmable ROM (EEPROM), or flash. Volatile memory may include random access memory (RAM) or external cache memory. As an illustration and not a limitation, RANI is available in many forms, such as static RAM (SRAM), dynamic RANI (DRAM), synchronous DRAM (SDRAM), double data rate SDRAM (DDRSDRAM), enhanced SDRAM (ESDRAM), synchronous link (Synchlink) DRAM (SLDRAM), memory bus (Rambus) direct RAM (RDRAM), direct memory bus dynamic RAM (DRDRAM), and memory bus dynamic RAM (RDRAM), etc.

The technical features of the above embodiments can be combined arbitrarily. In order to make the description concise, all possible combinations of the technical features in the above embodiments are not described. However, as long as there is no contradiction in the combination of these technical features, they should be It is considered as the range described in this specification.

The above-mentioned embodiments only express several implementation manners of the present application, and the description is relatively specific and detailed, but it should not be understood as a limitation on the scope of the invention patent. It should be pointed out that for those of ordinary skill in the art, without departing from the concept of this application, several modifications and improvements can be made, and these all fall within the protection scope of this application. Therefore, the scope of protection of the patent of this application shall be subject to the appended claims.

1. A method for marking dirty bits in an L2P table based on a solid state drive, comprising:
obtaining a marking request of dirty bits in the L2P table based on the solid state drive;
broadening a corresponding dirty bit in the L2P table to 2 bits according to the request;
setting the dirty bit from a binary number 00 to a binary number 01 through a state machine when a first write command request is obtained;
setting the dirty bit from the binary number 01 to a binary number 10 through the state machine when flush operation starts; and
setting the dirty bit from the binary number 10 to a binary number 11 through the state machine when a second write command request is obtained during the flush operation.

2. The method of claim 1, wherein after the step of setting the dirty bit from the binary number 10 to a binary number 11 through the state machine when a second write command request is obtained during the flush operation further comprises:
setting the dirty bit from the binary number 11 to a binary number 01 through the state machine when the flush operation is finished.

3. The method of claim 1, wherein after the step of setting the dirty bit from the binary number 01 to a binary number 10 through the state machine when flush operation starts further comprises:
if the second write command request is not obtained during the flush operation, resetting the dirty bit from the binary number 10 to a binary number 00 through the state machine when flush operation is finished.

4. The method of claim 1, wherein the method further comprises:
marking a corresponding dirty bit state by a state of the state machine;
if the dirty bit state is the binary number 00, it means that the L2P table in the cache and flash is consistent; and
if the dirty bit state is the binary number 01 or 10 or 11, it means that the L2P table in the cache and flash is inconsistent.

5. A device for marking dirty bits in an L2P table based on a solid state drive, comprising:
an obtaining module, configured for obtaining a marking request of dirty bits in the L2P table based on the solid state drive;
a broadening module, configured for broadening a corresponding dirty bit in the L2P table to 2 bits according to the request;
a first skipping module, configured for setting the dirty bit from a binary number 00 to a binary number 01 through a state machine when a first write command request is obtained, and setting the dirty bit from the binary number 01 to a binary number 10 through the state machine when flush operation starts; and
a second skipping module, configured for setting the dirty bit from the binary number 10 to a binary number 11 through the state machine when a second write command request is obtained during the flush operation.

6. The device of claim 5, wherein the second skipping module further configured for:
setting the dirty bit from the binary number 11 to a binary number 01 through the state machine when the flush operation is finished.

7. The device of claim 5, wherein the first skipping module further configured for:
if the second write command request is not obtained during the flush operation, resetting the dirty bit from the binary number 10 to a binary number 00 through the state machine when flush operation is finished.

8. The device of claim 5, wherein the device further comprises a state machine marking module, and the state machine marking module configured for:
marking a corresponding dirty bit state by a state of the state machine;
if the dirty bit state is the binary number 00, it means that the L2P table in the cache and flash is consistent; and
if the dirty bit state is the binary number 01 or 10 or 11, it means that the L2P table in the cache and flash is inconsistent.

9. A computer device, comprising: a memory, a processor, and a computer program stored on the memory and operating on the processor, wherein the processor implements the following steps when the processor executes the computer program:
obtaining a marking request of dirty bits in the L2P table based on the solid state drive;
broadening a corresponding dirty bit in the L2P table to 2 bits according to the request;
setting the dirty bit from a binary number 00 to a binary number 01 through a state machine when a first write command request is obtained;
setting the dirty bit from the binary number 01 to a binary number 10 through the state machine when flush operation starts; and
setting the dirty bit from the binary number 10 to a binary number 11 through the state machine when a second write command request is obtained during the flush operation.

10. The computer device of claim 9, wherein the processor further implements the following step when the processor executes the computer program:
setting the dirty bit from the binary number 11 to a binary number 01 through the state machine when the flush operation is finished.

11. The computer device of claim 9, wherein the processor further implements the following step when the processor executes the computer program:
if the second write command request is not obtained during the flush operation, resetting the dirty bit from the binary number 10 to a binary number 00 through the state machine when flush operation is finished.

12. The computer device of claim 9, wherein the processor further implements the following step when the processor executes the computer program:
marking a corresponding dirty bit state by a state of the state machine;
if the dirty bit state is the binary number 00, it means that the L2P table in the cache and flash is consistent; and
if the dirty bit state is the binary number 01 or 10 or 11, it means that the L2P table in the cache and flash is inconsistent.

13. A computer readable storage medium, a computer program is stored thereon, wherein the following steps are implemented when the computer program is executed by a processor:
obtaining a marking request of dirty bits in the L2P table based on the solid state drive;
broadening a corresponding dirty bit in the L2P table to 2 bits according to the request;
setting the dirty bit from a binary number 00 to a binary number 01 through a state machine when a first write command request is obtained;
setting the dirty bit from the binary number 01 to a binary number 10 through the state machine when flush operation starts; and
setting the dirty bit from the binary number 10 to a binary number 11 through the state machine when a second write command request is obtained during the flush operation.

14. The computer readable storage medium of claim 13, wherein the following step is implemented when the computer program is executed by the processor:
setting the dirty bit from the binary number 11 to a binary number 01 through the state machine when the flush operation is finished.

15. The computer readable storage medium of claim 13, wherein the following step is implemented when the computer program is executed by the processor:
if the second write command request is not obtained during the flush operation, resetting the dirty bit from the binary number 10 to a binary number 00 through the state machine when flush operation is finished.

16. The computer readable storage medium of claim 13, wherein the processor further implements the following step when the processor executes the computer program:
marking a corresponding dirty bit state by a state of the state machine;
if the dirty bit state is the binary number 00, it means that the L2P table in the cache and flash is consistent; and
if the dirty bit state is the binary number 01 or 10 or 11, it means that the L2P table in the cache and flash is inconsistent.
